(19) United States
(12) Patent Application Publication
(10) Pub. No.: US 2007/0021895 A1
(43) Pub. Date: Jan. 25, 2007

(54) System and method for monitoring the status of a work machine

(75) Inventors: Wayne David Brandt, Morton, IL (US); Vernon Richard Smith, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/185,705

(22) Filed: Jul. 21, 2005

(51) Int. Cl. G06F 7/70

(52) U.S. Cl. 701/50

(57) ABSTRACT

A status monitoring system for a work machine includes at least a first monitoring device coupled to a first component of the work machine and at least a second monitoring device coupled to a second component of the work machine. The status monitoring system also includes at least a first data collection node communicatively coupled to the first monitoring device and at least a second data collection node communicatively coupled to the second monitoring device. A status monitoring system further includes a status collection node in communication with each of the first and second data collection nodes, the status collection node configured to receive information corresponding to an operational status of the first and second components from the first and second data collection nodes and provide information corresponding to an operational status of the first and second components to an external user interface.

### TECHNICAL FIELD

This application relates generally to a work machine system and method, and more particularly to a system and method for monitoring the status of a work machine.

### BACKGROUND

Many of today's work machines are comprised of complex and sophisticated electrical and mechanical subsystems that rely heavily on various other systems, subsystems, and control elements. Often, these systems and subsystems employ sophisticated hardware, software, and/or firmware to function properly within the work machine. In addition, these systems include one or more electronic components such as, for example, electronic control units (ECUs) associated with a power source, transmission, or other subsystem of a work machine. The proper operation of these systems and subsystems may depend upon the real-time status monitoring, diagnostic analysis, and maintenance of the various electronic nodes of the equipment system.

In an effort to efficiently monitor the status of an equipment system, various diagnostic methods have been introduced to collect and distribute operational information of components of the system. For example, U.S. Pat. No. 5,848,365 (the '365 patent), issued to Coverdill, describes a diagnostic system for a truck. The system is part of an electronic control system of the truck and includes a plurality of electronic control units connected to an electrical wiring system. The diagnostic system may be configured with a clock, memory, and data logging unit for storage of event data. The data logging unit receives and stores voltage parameters on a common data bus upon realization of a particular predetermined event. According to the '365 patent, the particular predetermined event may be a short or open-circuit of the electrical system, wherein the voltage of the system deviates from a pre-determined voltage. The system of the '365 patent records voltages at the time of an event occurrence, for later analysis by a technician.

Although the system of the '365 patent may be effective for recording real-time voltage parameters associated with the occurrence of a predetermined event, it may be problematic and limited. For example, because data may only be stored for future acquisition by a service technician, significant damage may result from continued use of the system where a potential problem exists. Since the data logging unit may not be configured to transmit the information during the operation of the vehicle, the system of the '365 patent may be inoperable to provide data to an external user interface in real-time as the data is being received. In addition, should an event occur that indicates a potential failure of one or more of the electrical components, the event may not be realized until the service technician accesses the data logging unit. This may occur after a potential system breakdown, resulting in excessive personnel time and vehicle inactivity costs.

Furthermore, in order to properly perform as a diagnostic system, an event must be realized by at least one of the electronic control units. Should the electrical parameter of any one of the electronic control units change, but not deviate substantially enough to provoke an event, the diagnostic system of the '365 patent would no longer function as such. This may result in undetected and undiagnosed fluctuations, which may indicate potential problems with the system. Furthermore, although the system of '365 patent may perform as a diagnostic system when an event is realized, the system may only be configured to record voltages on the system deviating from predefined voltages.

Furthermore, during the operation of an electrical or mechanical system, status changes may be realized for a variety of characteristic parameters, unrelated to voltage parameters. For example, system configuration changes, wiring changes, or changes in control software may all occur during the normal operation of the vehicle. These changes, if not properly monitored and/or recorded, may lead to loss of functionality of the equipment system or, potentially, failure of the entire system.

The presently disclosed system and method are directed to overcoming one or more of the problems set forth above.

### SUMMARY OF THE INVENTION

In accordance with one aspect, the present disclosure is directed toward a status monitoring system for a work machine. The system may include at least a first monitoring device coupled to a first component of the work machine and at least a second monitoring device coupled to a second component of the work machine. The system may also include at least a first data collection node communicatively coupled to the first monitoring device and at least a second data collection node communicatively coupled to the second monitoring device. The system may further include a status collection node in communication with each of the first and second data collection nodes, the status collection node may be configured to receive information corresponding to an operational status of the first and second components from the first and second data collection nodes, and may provide information corresponding to an operational status of the first and second components to an external user interface.

According to another aspect, the present disclosure is directed toward a method for collecting data from a plurality of components of a work machine. The method may include receiving operational information of each of the plurality of components of the work machine. The method may also include collecting the received operational information in a status collection node. The method may further include receiving a data query from an external user interface and providing the collected operational information to the external user interface in response to the data query.

In accordance with yet another aspect, the disclosed embodiment includes a method for determining the status of a plurality of components of a work machine. The method may include receiving operational information of each of the plurality of components of the work machine. The method may also include collecting the received operational information in a status collection node. The method may further include determining a status of each of the plurality of components of the work machine based on the received information. The method may also include providing at least one of a signal corresponding to the status of the each of the plurality of components and the collected information to an external user interface.

### BRIEF DESCRIPTION OF THE DRAWINGS

FIG. 1 provides a diagrammatic perspective view of an exemplary disclosed work machine;

FIG. 2 provides a diagrammatic view of an exemplary disclosed status monitoring system for the work machine in FIG. 1; and

FIG. 3 illustrates an exemplary disclosed method for operating the status monitoring system of FIG. 2.

### DETAILED DESCRIPTION

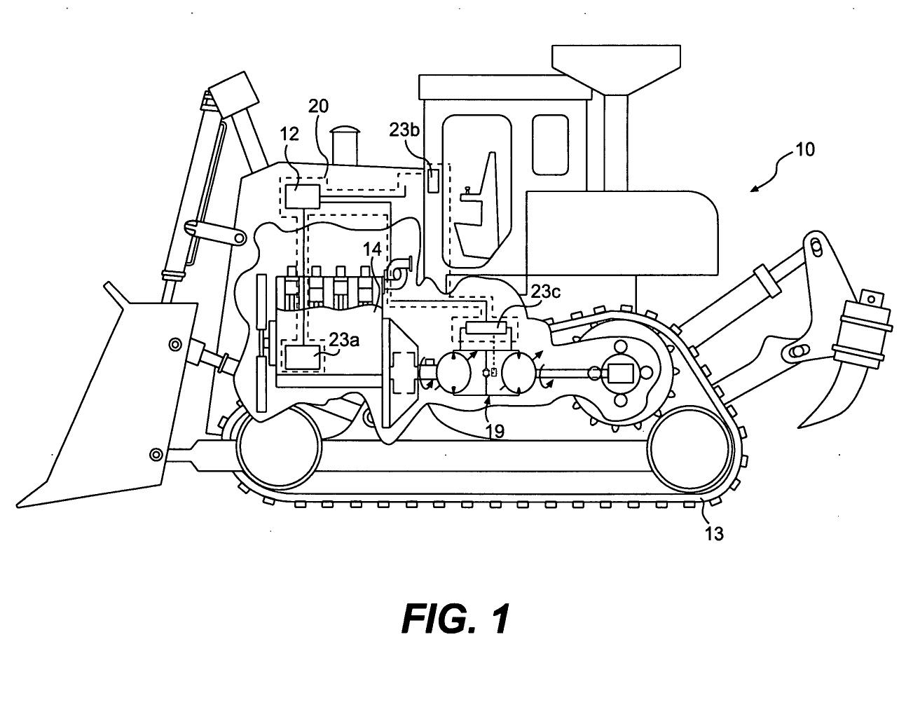

FIG. 1 provides a diagrammatic perspective view of a work machine 10 according to an exemplary disclosed embodiment. Work machine 10 may be a stationary or mobile machine that performs some type of operation associated with an industry such as mining, construction, farming, transportation, or any other industry known in the art. While work machine 10 is illustrated as a track type tractor, work machine 10 may embody any type of work machine that includes one or more systems operable to perform a particular function. For example, work machine 10 may embody an on-highway vehicle, an off-highway vehicle, a wheel loader, an excavator, a skid steer loader, a generator set, or any other type of machinery. Work machine 10 may include, among other things, a power source 14, a transmission system 19, and a status monitoring system 20. It is contemplated that work machine 10 may include additional and/or different components than those listed above.

Power source 14 may be operable to provide a power output for various operations of work machine 10. Power source 14 may be associated with various electrical and mechanical systems of work machine 10 such as, for example, a generator (not shown) for converting a portion of the power output to electric energy, a transmission 19 for transmitting power from power source 14 to one or more traction devices 13, a cooling system (not shown) for cooling various components of power source 14, a lubrication circuit (not shown) to provide a lubricating fluid to power source 14, a fuel system (not shown) for providing fuel to power source 14, an implement system (not shown), or any other electrical or mechanical system operable to perform a function of work machine 10. Power source 14 may include a battery, a fuel cell, or an internal combustion engine that operates using diesel fuel, gasoline, a gaseous fuel such as natural gas, or other types of fuel.

Transmission 19 may be operable to transmit power from power source 14 to one or more traction devices 13. Transmission 19 may be a hydrostatic transmission, an electric transmission, a mechanical transmission, a hydro-mechanical transmission or any other means for transmitting power from power source 14 to traction device 13. Transmission 19 may be associated with various electrical or mechanical systems of work machine 10 such as, for example, a torque converter for adjusting output torque from power source 14, traction device 13 for propelling and maneuvering work machine 10, a lubrication circuit for cooling and/or lubricating transmission 19, or any other electrical or mechanical system operable to perform a function of work machine 10.

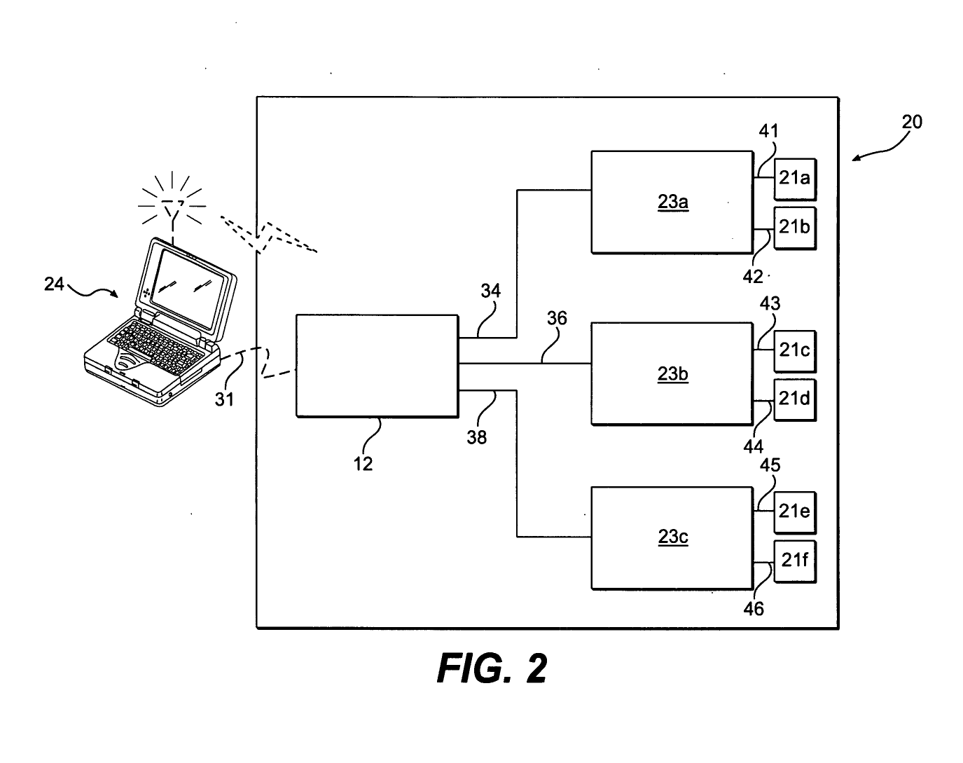

Status monitoring system 20 may include devices operable to receive, analyze, and provide data information corresponding to the operational characteristics of power source 14, transmission 19, and/or other electrical and mechanical systems of work machine 10. For example, referring to FIG. 2, status monitoring system 20 may include one or more data collection nodes 23a-c, one or more monitoring devices 21a-f, and a status collection node 12. Status monitoring system 20 may be removeably coupled to an external user interface 24, which may be operable to receive and analyze information collected from status monitoring system 20.

Data collection nodes 23a-c may include various components for running software applications. For example, data collection nodes 23a-c may include a central processing unit (CPU), a computer-readable memory, a read only memory (ROM), a random access memory (RAM), a battery backed RAM (BBRAM), an electrically eraseable programmable ROM (EEPROM), input/output (I/O) elements, etc. Data collection nodes 23a-c may constitute a unit dedicated to the status monitoring system 20, or alternatively, may coincide with a control unit of work machine 10.

Data collection nodes 23a-c may be operable to perform a variety of monitoring, collection, and control functions of the electrical or mechanical systems of work machine 10. For example, as illustrated in FIG. 1a data collection node 23a may be associated with the electrical or mechanical systems of power source 14 to monitor and/or control an operation of power source 14. In particular, data collection node 23a may be operable to monitor and/or control an exhaust pressure of power source 14, a flow rate or temperature of fluid flowing through a cooling system of power source 14, a gas sensor of an exhaust system of power source 14, a viscosity of hydraulic fluid supplied by a pump of power source 14, an air/fuel mixture supplied to a combustion chamber, or another function of power source 14.

Additionally, a data collection node 23b may be associated with a steering system to control the steering and maneuverability of work machine 10.

For example, data collection node 23b may be operable to monitor and/or control the displacement of the power steering pump, a pressure sensor for monitoring pressure of the power steering fluid, an electronic relay for protecting the electronics of the steering control system, or another function of the steering system.

Similarly, a data collection node 23c may be associated with transmission 19 to monitor and/or control an operation of transmission 19. For example, data collection node 23c may be operable to monitor and/or control the displacement of a hydraulic pump or motor of transmission 19, the shaft speed of an electric or hydraulic motor, a current or voltage input to an electric motor, a valve position for controlling the pressure of a hydraulic line, a viscosity of hydraulic fluid in a hydraulic pump or clutch, or another function of transmission 19.

Monitoring devices 21a-f may be coupled to data collection nodes 23a-c and operable to collect and transmit a variety of operational characteristics of one or more of the electrical or mechanical components of work machine 10 to data collection nodes 23a-c. For the purposes of this disclosure, monitoring devices 21a-f may periodically or continuously automatically transmit information to data collection nodes 23a-c or transmit information to data collection nodes upon query from data collection nodes 23a-c. Monitoring devices 21a-f may include, for example, temperature or pressure sensors, flow rate or velocity meters, actuators, electronic relays or circuit breakers, or any such device known in the art for monitoring physical or operational characteristics of a system. For example, monitoring devices 21a-f may include a temperature sensor for monitoring the cooling fluid of power source 14, a viscosity sensor for measuring the viscosity of hydraulic fluid within transmission 19, a pressure sensor for measuring hydraulic fluid pressure of transmission 19, a fuel sensor for monitoring fuel flow into power source 14, an electrical relay for ignition system protection, or any of a number of similar operational data collection devices known in the art.

Monitoring devices 21a-f may be in communication with data collection nodes 23a-c via communication lines 41-46 respectively. Communication lines 41-46 may include electrical wires, twisted pair cables, optical fiber cables, wireless links, infrared links, Bluetooth connections, or any other media know in the art for transmission of data information. Data information may be transmitted using an analog format, a digital format, a combination thereof, or any other format of data communication known in the art to communicate information over communication lines 41-46.

Status collection node 12 may embody an electronic system operable to communicate with one or more of the plurality of data collection nodes 23a-c of work machine 10, analyze data information, and provide information to external user interface 24. For example, status collection node 12 may include a master control unit, such as an electronic control unit (ECU) of the work machine, a system computer, a network manager, or any such electronic device that may be in communication with data collection nodes 23a-c. Status collection node 12 may include various components for running software applications. For example, status collection node 12 may include a central processing unit (CPU), a computer-readable memory, a read only memory (ROM), a random access memory (RAM), a battery backed RAM (BBRAM), an electrically eraseable programmable ROM (EEPROM), input/output (I/O) elements, etc. Status collection node 12 may be a stand-alone unit dedicated to the status monitoring system, or alternatively, may be integrated within a centralized data system of work machine 10. For example, status monitoring system 20 may constitute part of a network management system of work machine 10, an electronic control unit (ECU) of work machine 10, or a centralized computing system of work machine 10. Furthermore, status collection node 12 may include one of data collection nodes 23a-c or may be designated and/or selected from among data collection nodes 23a-c using software or firmware which may be operable, when executed, to designate one of data collection nodes 23a-c as the status collection node.

Status collection node 12 may be configured to determine the status of one or more of the electrical or mechanical systems of work machine 10 associated with data collection nodes 23a-c and/or store the information in computer-readable memory. Specifically, status collection node 12 may receive one or more operational characteristics of the mechanical or electrical systems of work machine 10 from data collection nodes 23a-c, store the operational characteristics in memory, and analyze the operational characteristics to determine the status of the component. For example, status collection node 12 may receive an operational characteristic from data collection node 23c corresponding to transmission 19 such as, for example, the pressure of the hydraulic fluid in the hydraulic pump. Status collection node 12 may verify that the operational characteristic falls within an acceptable, predetermined range and conclude that the transmission system is performing appropriately. Status collection node 12 may store all or part of the received information and the resulting analysis in memory and/or provide the information and analysis to external user interface 24, when prompted by external user interface 24.

Status collection node 12 may also analyze the operational characteristics of the mechanical or electrical systems of work machine 10 received from data collection nodes 23a-c to determine an overall status of work machine 10. For example, status collection node 12 may receive operational characteristics of transmission 19, power source 14, and/or various other mechanical and electrical systems from data collection nodes 23a-c. Status collection node 12 may verify that all of the operational characteristics received from data collection nodes 23a-c are within acceptable, predetermined ranges and conclude that the work machine is in operation and/or is operating properly. Status collection node 12 may store all received information and the resulting analysis in memory and/or provide the information and analysis to external user interface 24, when prompted by external user interface 24.

Status collection node 12 may be communicatively coupled to data collection nodes 23a-c via communication lines 34, 36, and 38, respectively. Communication lines 34, 36, and 38 may include electrical wires, twisted pair cables, optical fiber cables, wireless links, infrared links, Bluetooth connections, or any other media know in the art for transmission of data information. Data information may be transmitted using an analog format, a digital format, or any combination thereof to communicate information over communication lines 34, 36, and 38.

External user interface 24 may be operable to communicate with status monitoring system 20 for diagnostic, status monitoring, and maintenance purposes and may include various components for running software applications. For example, external user interface 24 may include a central processing unit (CPU), a random access memory (RAM), a computer readable medium, input/output elements, and a program stored in computer-readable medium. External user interface 24 may be configured to query and receive information from the status monitoring system 20, provide software updates to the status monitoring system 20, and analyze information received from status monitoring system 20. While external user interface 24 is illustrated as a computer, external user interface 24 may include any type of analytical device that is capable of data transfer and analysis. For example, external user interface 24 may include, among other things, a portable data assistant (PDA), a diagnostic monitor, a wireless device, or a satellite-based communication system. For the purposes of the present disclosure, external user interface includes a user interface that may be external to status collection node 12, data collection nodes 23a-c, and monitoring devices 21a-f.

External user interface 24 may be in communication with status collection node 12 via a communication line 31. Communication line 31 may include electrical wires, twisted pair cables, optical fiber cables, wireless links 32 such as infrared links, Bluetooth connections, satellite communication, or any other media known in the art for transmission of data information. Data information may be transmitted using an analog format, a digital format, a combination thereof, or any other format of data communication known in the art to communicate information over communication line 31.

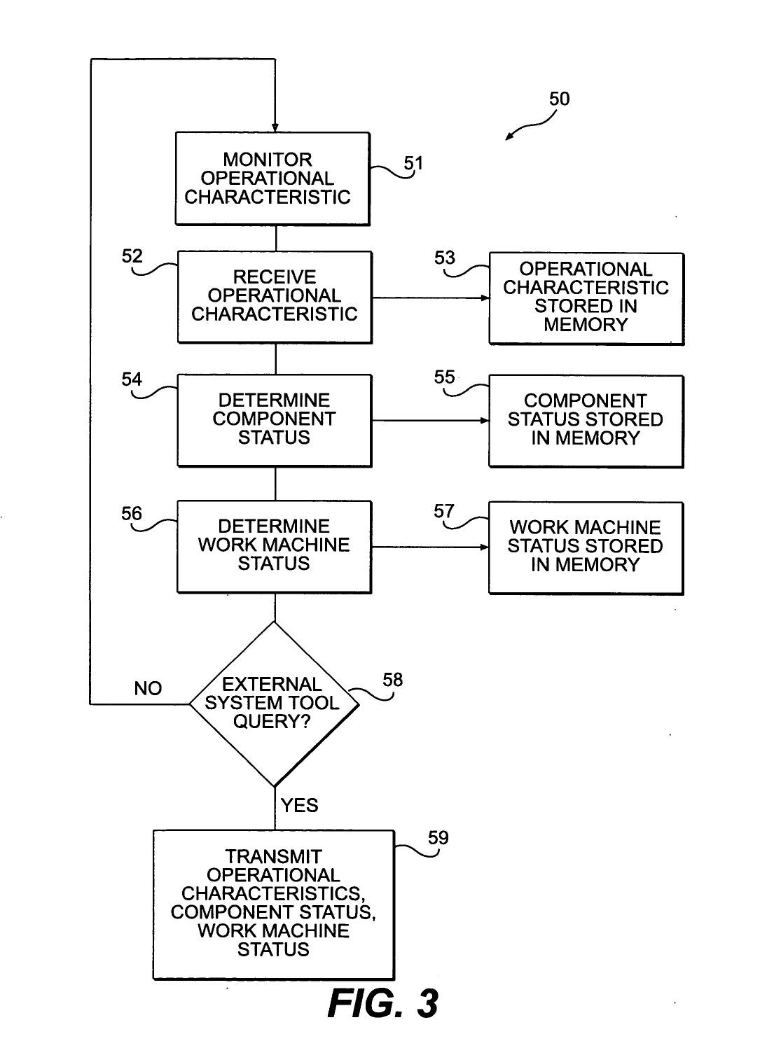

FIG. 3 illustrates a flow chart 50 of exemplary methods of operating status monitoring system 20. FIG. 3 will be described in detail below.

### INDUSTRIAL APPLICABILITY

The disclosed status monitoring system may be operable to collect and monitor one or more operational characteristics of a work machine and to determine a status of the work machine. In particular, the status monitoring system may be operable to receive data information from one or more components and/or subsystems of the work machine and to provide the information and/or status to an external user interface. In one exemplary embodiment, the status monitoring system may determine a general operational status of the work machine and provide the general operational status indication to the external user interface. The operation of status monitoring system 20 will now be described in detail.

As illustrated in flow chart 50 of FIG. 3, the operation of status monitoring system 20 initiates when one or more monitoring devices 21a-f monitor one or more operational characteristic of an electrical or mechanical system of work machine 10 and transmits the operational characteristics to status collection node 12 via data collection nodes 23a-c (Step 51). For example, monitoring device 21a may be a temperature sensor associated with power source 14, which is operable to monitor the temperature of a cooling fluid passing through power source 14. Monitoring device 21a may monitor the temperature of the cooling fluid, obtain temperature data, and provide the temperature data to data collection node 23a associated with power source 14. Data collection node 23a may receive temperature data and transmit the temperature data to status collection node 12.

The operational characteristic of the electrical or mechanical systems received by status collection node 12 (Step 52) may then be stored in memory (Step 53). For example, the temperature data received from the temperature sensors associated with power source 14 of the example above may then be stored in memory of status collection node 12 for future monitoring and analysis.

Status monitoring system 20 may make a determination of the status of the electrical or mechanical system based upon the received operational characteristics of the electrical or mechanical systems (Step 54), the results of which may be stored in memory (Step 55). For example, status monitoring system 20 may compare the monitored temperature of the example above with a specified predetermined operating temperature range or threshold value of the measured system. Status monitoring system 20 may then determine whether power source 14 is or is not operating normally and store the status determination in memory, for future monitoring and analysis.

Status monitoring system 20 may make a determination of the general operating status of work machine 10 based upon the monitored operational characteristics of the electrical or mechanical systems, the determined status of the electrical or mechanical systems, and/or a combination thereof (Step 56), and may store the general operational status determination in memory (Step 57). For example, status monitoring system 20 may determine that, since the temperature measurement of the above example is within a predetermined range or above a predetermined threshold value, work machine 10 is operational and/or is operating normally. This determination may then be stored in memory for future access by external user interface 24.

Status monitoring system 20 may detect a query from external user interface 24 (Step 58) and transmit real-time measurement, determined status information, and/or any other data information stored in memory to external user interface 24 (Step 59). For example, upon detection of a query from external user interface 24, status monitoring system 20 may transmit the temperature measurement of the above example, the determined status of power source 14, and/or the determined general operational status of work machine 10 to external user interface 24. It is contemplated in this disclosure that status monitoring system may also transmit periodically or continuously, with or without a query from external user interface 24. Furthermore, the method for status monitoring system 20 may be repeatable periodically or continuously during the operation of work machine 10. Steps 51-57 may be periodically or substantially continuously repeated, based upon a predetermined configuration of status monitoring system 20. In addition, it is contemplated in this disclosure that steps 51-59 may be performed in different order while still achieving substantially the same operation as status monitoring system 20.

Because the status collection node 12 may be communicatively coupled to each of the one or more data collection nodes 23a-c to collect all data information monitored by data collection nodes 23a-c, status monitoring system 20 may require less time to access operational data of the various components and/or subsystems of work machine 10. For example, since status collection node 12 may substantially simultaneously collect information from one or more data collection nodes 23a-c and may substantially simultaneously provide the information to external user interface 24, the time required to query each of the plurality of data collection nodes 23a-c may be reduced. Since all of the information is received by status collection node 12, external user interface 24 has immediate access to component status information once in communication with status monitoring system 20. This may eliminate the time needed to query each data collection node 23a-c of work machine 10, and may substantially reduce the time required by the technician for data collection and diagnostic analysis.

Furthermore, status monitoring system 20 may increase personnel and equipment efficiency. For example, since status collection node 12 may wirelessly communicate data information to external user interface 24, data information from status monitoring system 20 may be accessible while the work machine is operating. As a result, the work machine need not be in an idle state to access the information provided by status monitoring system 20. In addition, since status monitoring system 20 may continuously provide data information during operation of work machine 10, status monitoring system 20 may not be limited to monitoring characteristics only upon the realization of a particular event.

Status monitoring system 20 may improve the accessibility and searchability of diagnostic information. For example, since all of the data information is centrally located with status collection node 12, the data may be manipulated by external user interface 24 to display certain operational characteristics of interest to the technician. For example, if temperature of the coolant system is of particular interest, external user interface 24 may sort through data information corresponding to a coolant temperature sensor once connected to status monitoring system 20.

It will be apparent to those skilled in the art that various modifications and variations can be made to the disclosed status monitoring system without departing from the scope of the invention. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A status monitoring system for a work machine, comprising:
at least a first monitoring device coupled to a first component of the work machine;
at least a second monitoring device coupled to a second component of the work machine;
at least a first data collection node communicatively coupled to the first monitoring device;
at least a second data collection node communicatively coupled to the second monitoring device; and
a status collection node in communication with each of the first and second data collection nodes, the status collection node configured to:
receive information corresponding to an operational status of the first and second components from the first and second data collection nodes, and
provide information corresponding to an operational status of the first and second components to an external user interface.

2. The status monitoring system of claim 1, wherein the status collection node includes an electronic control unit of the work machine.

3. The status monitoring system of claim 1, wherein at least one of the first and second monitoring devices includes a data sensor.

4. The status monitoring system of claim 1, wherein the external user interface is in selective communication with the status collection node.

5. The status monitoring system of claim 4, wherein the external user interface is in wireless communication with the status collection node.

6. The status monitoring system of claim 1, wherein the status collection node includes at least one of the first and second data collection nodes, the status collection node further configured to determine a status of the work machine based upon the received information.

7. A method for collecting data from a plurality of components of a work machine, comprising:
receiving operational information of each of the plurality of components of the work machine;
collecting the received operational information in a status collection node;
receiving a data query from an external user interface; and
providing the collected operational information to the external user interface in response to the data query.

8. The method of claim 7, further including determining the status of at least one of the plurality of components based on the collected information.

9. The method of claim 7, further including determining a status of the work machine based on the collected information.

10. The method of claim 9, wherein the determination of the status of the work machine is further based upon a predetermined operational range of each of the plurality of components.

11. The method of claim 9, further including storing at least one of the collected information and the status of the work machine.

12. The method of claim 9, further including transmitting at least one of the collected information and the status of the work machine to the external user interface.

13. The method of claim 7, wherein the receiving operational information further includes periodically sending a request signal to at least one of a first data collection node and a second data collection node and receiving the operational information in response to the request signal.

14. A method for determining the status of a plurality of components of a work machine, comprising:
receiving operational information of each of the plurality of components of the work machine;
collecting the received operational information in a status collection node;
determining a status of each of the plurality of components of the work machine based on the received information; and
providing at least one of a signal corresponding to the status of the each of the plurality of components and the collected information to an external user interface.

15. The method of claim 14, further including:
determining a status of the work machine based upon the status of each of the plurality of components; and
providing a signal corresponding the status of the work machine to an external user interface.

16. The method of claim 15, wherein the determination of the status of the work machine is further based upon a predetermined operational range of each of the plurality of components.

17. The method of claim 15, further including storing at least one of the collected information and the status of the work machine.

18. The method of claim 15, further including transmitting the at least one of the collected information and the status of the work machine to the external user interface.

19. The method of claim 14, wherein the receiving operational information further includes periodically sending a request signal to at least one of the plurality of components and receiving the operational information in response to the request signal.

20. A work machine, comprising:
a power source;
a status monitoring system, operably connected to the power source, the status monitoring system comprising:
a plurality of first monitoring devices coupled to a first component of the work machine to receive the operational information of the first component;
a plurality of second monitoring devices coupled to a second component of the work machine to receive the operational information of the second component;
at least a first data collection node communicatively coupled to the first monitoring device to receive the operational information of the first component;
at least a second data collection node communicatively coupled to the second monitoring device to receive the operational information of the second component;
a status collection node in communication with each of the first and second data collection nodes, the status collection node configured to:
receive the operational information from the first and second data collection nodes, and provide information corresponding to an operational status of the first and second components to an external user interface.

21. The status monitoring system of claim 20, wherein the status collection node is further configured to determine a status of each of the first and second components based on the received operational information.

22. The status monitoring system of claim 21, wherein the status collection node is further configured to determine a status of the work machine based upon the received operational information.

23. The status monitoring system of claim 22, wherein at least one of the operational information of the first and second components, the status of the first and second components, and the status of the work machine are stored in memory of the status monitoring system.

24. The status monitoring system of claim 22, wherein the external user interface is in wireless communication with the status collection node.
